(19) United States
(12) Patent Application Publication
(10) Pub. No.: US 2012/0007277 A1
(43) Pub. Date: Jan. 12, 2012

(54) DEVICE AND METHOD FOR FORMING MULTILAYERED LAMINATES

(75) Inventors: Eiji Nakamura, Houston, TX (US); Nozomu Sugoh, Okayama (JP); Tomiaki Otake, Chiba (JP); Joey Mead, Carlisle, MA (US); Stephen Orroth, Windham, NH (US); Carol Barry, Tyngsborough, MA (US); Mithun Kamath, Lowell, MA (US); Scott Winroth, Ayer, MA (US)

(73) Assignees: KURARAY CO., LTD., Tokyo (JP); UNIVERSITY OF MASSACHUSETTS LOWELL, Lowell, MA (US)

(21) Appl. No.: 13/056,411

(22) PCT Filed: Aug. 5, 2009
(86) PCT No.: PCT/US09/52805

§ 371 Date: Sep. 23, 2011

Related U.S. Application Data
(60) Provisional application No. 61/086,364, filed on Aug. 5, 2008.

(51) Int. Cl. B29C 39/12; B29C 33/40; B29C 70/00

(52) U.S. Cl. 264/241; 425/447

(57) ABSTRACT

Methods and devices for forming a vertically-oriented multilayer laminates, for example, a vertically-oriented multilayer laminates, are provided. The laminates may be fabricated by hardenable fluids, for example, polymers that are directed along flow paths to divide, repossession, and combine streams to provide the desired laminated structure. The flow divisions and recombination may be practiced repeatedly wherein laminates have tens or even tens of thousands of individual layers may be produced. The polymers used may have comparable viscosities, for example, having viscosity ratios of less than 3. Though aspects of the invention may be used packaging, aspects of the invention may be applied to any field where laminated structures are desired.

### CROSS-REFERENCE TO RELATED APPLICATION

This application claims priority from pending U.S. Provisional Patent Application 61/086,364, filed on Aug. 5, 2008, the disclosure of which is included by reference herein in its entirety.

### BACKGROUND

1. Field of the invention

The present invention relates to methods and devices for forming multi-layer laminates from flowable, hardenable material, for example, from polymers. In particular, devices and methods are provided that channel flowable material though flow passages to divide, reshape, and position flow streams prior to hardening the material.

2. Description of Related Art

The laminated sheets or films are commonly used as in a variety of industries, for example, for packaging, environmental isolation, optical properties, and for structural stability. The potential optical properties of laminated polymers make them useful in the optics industry. The mechanical properties of laminated film and sheeting are also advantageous to the electronics industry and photovoltaic industry, for example, as substrates for mounting active components. With advances in these and other industries, the need arises for improved laminates having enhanced barrier, optical, and structural properties.

Various methods and devices are disclosed in the prior art for providing laminated polymer structures. For example, U.S. Pat. Nos. 3,195,865; 3,239,197; 3,557,265; 5,094,788; and 5,628,950 disclose various methods and devices for manipulating fluid polymer streams. However, as will become clear from the following description, none of this and related prior art provides the advantages of the present invention, for example, the capability to provide vertically oriented polymer laminates.

### BRIEF SUMMARY OF ASPECTS OF THE INVENTION

Aspects of the present invention comprise various devices and methods for forming vertically oriented laminate structures for use in many different kinds of applications, including, for example, for use in films and sheets for the optical, the electronics, the industrial, and packaging fields.

One aspect is a method of forming a multilayer laminate, for example, a vertically-oriented multilayer laminate, including or comprising providing at least a first stream of a first hardenable fluid and a second stream of a second hardenable fluid; combining the first stream with the second stream to provide a combined stream of fluid comprising the first fluid and the second fluid; dividing the combined stream into a plurality of streams, each of the plurality of streams comprising the first fluid and the second fluid; positioning the plurality of streams laterally adjacent each other; and fusing the plurality of laterally adjacent streams to provide a vertically-oriented multilayer laminate. In one aspect, the method further comprises dividing the first stream into two streams of the first fluid, and wherein combining the first stream with the second stream comprises combining the two streams of the first fluid with the second stream to provide the third stream.

Though aspects of the invention may be applied to any flowable, hardenable material, in one aspect of the invention, the flowable material comprises a polymer, for example, a polyolefin resin, a polyester resin, a polyamide resin, a polyvinyl alcohol resin, an acrylic resin, a polyoxymethylene resin, a styrene resin, a polycarbonate resin, a polyphenylene ether resin, or a soft vinyl chloride resin, natural rubber, isoprene rubber, a polyurethane elastomer, a polyamide elastomer, a polystyrene elastomer, or combinations thereof, among other resins. The flowable material, for example, one or more of the above materials, may also include organic or inorganic additives, for example, a liquid, a lubricant, a photostabilizer, a flame retarding agent, an antistatic agent, a UV absorber, an antioxidant, a foaming agent, a photo initiator, etc., or a combination thereof.

Another aspect of the invention is a multilayer laminate forming device, for example, a vertically-oriented multilayer laminate forming device, including or comprising a feed block adapted to receive a first stream of a first hardenable fluid and a second stream of a second hardenable fluid and combine the first stream with the second stream to provide a combined stream of hardenable fluid comprising the first fluid and the second fluid; a layer multiplying section adapted to divide the combined stream into a plurality of streams, each of the plurality of streams comprising the first fluid and the second fluid; a layer positioning section adapted to position the plurality of streams laterally adjacent each other; and a layer fusing section adapted to fuse the plurality of latterly adjacent streams to provide a vertically-oriented multilayer laminate. In one aspect, the device may further comprise a divider adapted to divide the first stream into two first streams of the first polymer, and wherein the feed block is adapted to combine the two first streams with the second stream to provide the combined stream. Again, the first and second hardenable material may comprise one or more of the polymers, resins, or plastics listed above.

According to aspects of the invention, methods and devices are provided that can be adapted to provide multilayer laminates having tens, hundreds, thousands, tens of thousands, hundreds or thousands, or millions, or even tens of millions or more of vertically oriented layers, for example, of two or more materials, for instance, two or more alternating materials, or repeating sequences of materials. These multilayer laminates may be provided by providing and combining as many streams of hardenable material.

These and other aspects, features, and advantages of this invention will become apparent from the following detailed description of the various aspects of the invention taken in conjunction with the accompanying drawings.

### BRIEF DESCRIPTION OF FIGURES

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a schematic diagram of a process of forming a multilayer laminate according to one aspect of the invention.

FIG. 2 is schematic illustration of a comparison of the vertically oriented layering provided by aspect of the present invention compared to the horizontal oriented layering provided by the prior art.

FIG. 3 is a schematic illustration of a method of forming a multilayer laminate according to one aspect of the invention.

FIG. 4 is a perspective view of a device for forming a multilayer laminate according to one aspect of the invention.

FIG. 5 is a perspective view the three-dimensional flow paths of the polymers according to one aspect of the invention.

FIG. 6a is an exploded perspective view of the polymer flow transition plates according to one aspect of the invention.

FIG. 6b is an exploded perspective wire frame view of the polymer flow transition plates shown in FIG. 6a.

FIG. 7 is a detailed perspective view of the three-dimensional flow paths of the polymers according to one aspect of the invention.

FIG. 8 is a photograph of a film having multiple vertically oriented layers according to an aspect of the invention.

FIG. 9 is a table summarizing the Examples of aspects of the invention presented

FIG. 10 is a photograph of a laminate produced according to an aspect of the invention.

### DETAILED DESCRIPTION OF ASPECTS OF THE INVENTION

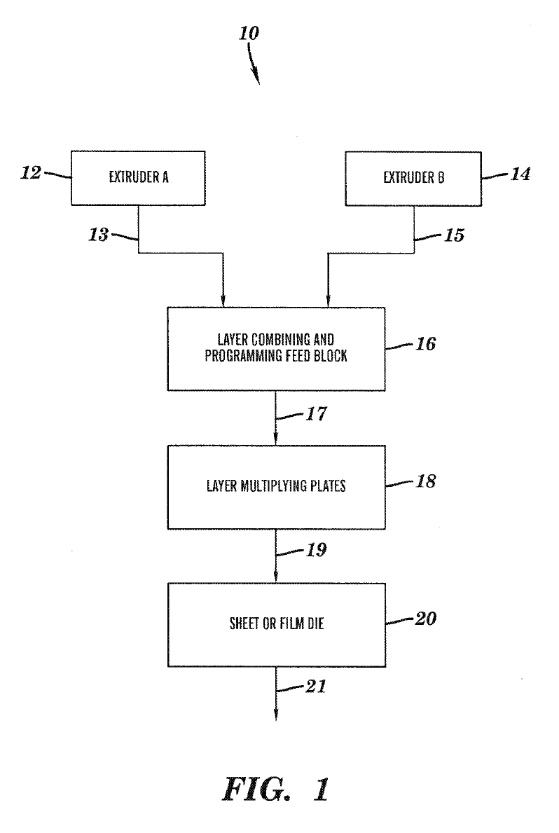

FIG. 1 is a schematic diagram of a process 10 of forming a multilayer laminate according to one aspect of the invention. As shown, the process typically begins by introducing one or more hardenable materials, for example, fluid polymers, to two extruders 12 and 14. Though in aspects of the invention any hardenable material may be used, that is, any material having a first viscosity under one set of conditions and a second viscosity under a second set of conditions, to facilitate the discussion of aspects of the invention, the term “polymer” and “polymers” will be used in the following descriptions. It will be understood that these terms will represent any type of hardenable material that may be used in aspects of the invention. Though two or more extruders 12, 14 may be used in aspects of the invention, in the aspect shown in FIG. 1, two extruders 12 and 14 are shown, where extruder 12 receives a first polymer A and extruder 14 receives a second polymer B. Typically, the polymers may be heated in extruders 12 and 14, for example, to a temperature of between about 200 degrees C. and 400 degrees C., to reduce the viscosity of the polymers whereby they can be discharged from extruders 12 and 14 and handled for subsequent treatment.

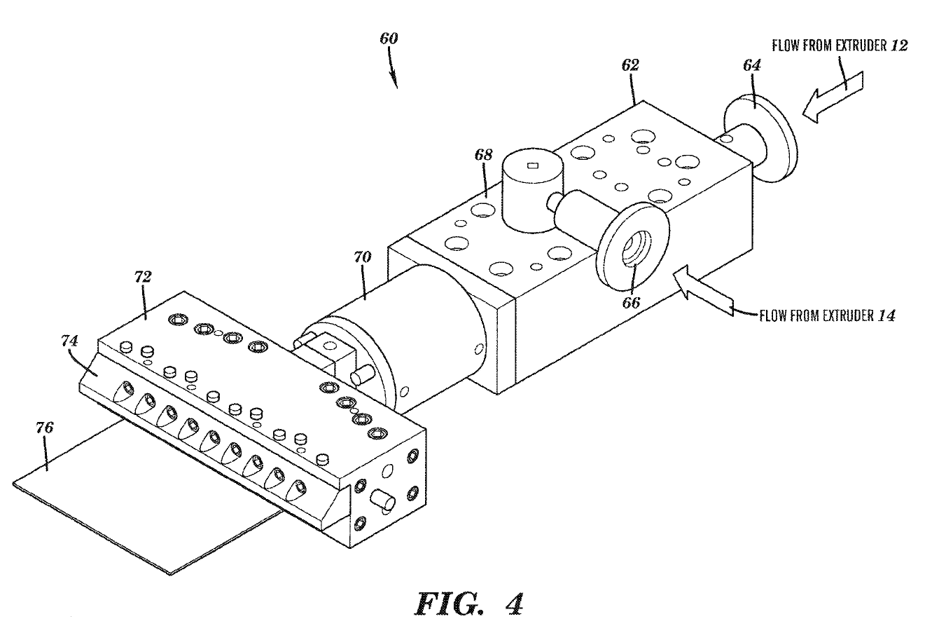

As shown in FIG. 1, the polymers extruded from extruder 12 and from extruder 14, that is, extruded polymers 13 and 15, respectively, are introduced to a layer combing and programming process 16 to form an initial layered structure 17, that is, a combined stream of fluid comprising the first polymer A and the second polymer B. (For example, the polymers A and B may be fed to a combining device as shown in FIG. 4 below.) After combining 16, the combined stream 17 of polymer A and polymer B is forwarded to a layer multiplication process 18. Layer multiplication process 18 divides the combined stream 17 into a plurality of streams, each of the plurality of streams comprising the first polymer A and the second polymer B. The layer multiplication process 18 produces a stream 19 comprising a combined stream of the plurality of streams of first polymer A and polymer B. The number of layer multiplications may range from 1 to 10s of thousands, for example, the layer multiplication 18 may only be limited by the size and of the streams and the space available. Typically, multiplication process 18 may also position the plurality of streams adjacent each other, for example, laterally adjacent, and at least partially fuse the plurality of adjacent streams to provide a multilayer laminated stream 19, for example, a vertically oriented multiplayer laminate stream.

Then, the combined stream 19 of the plurality of streams is introduced to a sheet or film forming process 20, for example, a sheet or film forming die, to provide a sheet or film 21 of multilayer polymers A, B, C, etc. The sheet or film forming processing 20 typically produces sheet or film 21 by increasing the width of the steam 19 while decreasing the height of stream 19.

According to aspect of the invention, the number of layers and types of polymers A, B, C, etc. contained in sheet or film 21 is dependent upon the number of polymers A, B, C, etc. introduced to the layer combining process 16 and the number of layer multiplications 18. According to aspects of the invention, sheet or film 21 may include more than 1000 individual polymer components.

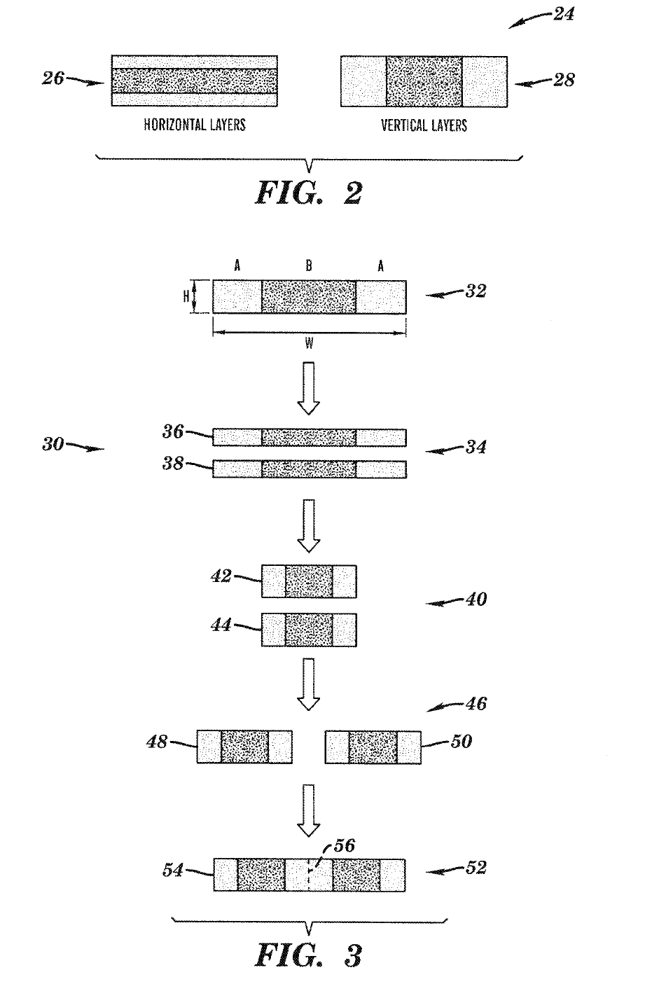

FIG. 2 is schematic illustration 24 of a comparison of a typically horizontally oriented layering 26 provided by the prior art compared to a typical vertically oriented layering 28 provided by aspects of the invention. However, in one aspect of the invention, a horizontal oriented layering 26 may be provided by the methods and devices of the invention. For example, U.S. Pat. Nos. 3,195,586; 3,557,265; 5,094,788; and 5,628,950 all disclose methods and devices that produce horizontally oriented layering, for example, as shown at 26 in FIG. 2. U.S. Pat. No. 3,239,197 disclose methods and devices that produce vertically orientated layering, but only as a preliminary step prior to mixing the layers together. The prior art does not provide any methods or devices that form multiple vertically oriented layers, as shown at 28 in FIG. 2.

FIG. 3 is a schematic illustration 30 of a method of forming a multilayer laminate according to one aspect of the invention. FIG. 3 schematically illustrates a sequence of handling polymer streams using devices and methods of the present invention, for example, including polymer layer division, polymer layer repositioning, and polymer layer recombination according to aspects of the invention. For example, in FIG. 3, a representative cross section 32 is shown having a polymer stream comprising a plurality of polymer components A, B. C, etc., a height “H,” and a width “W.” Cross section 32 may be formed in the layer combing and programming process 16 shown in FIG. 1 and represented by combined stream 17 in FIG. 1. In the aspect shown in FIG. 3, section 32 includes sequence of two polymers, A and B, having two components of polymer A flanking a single component of polymer B, that may be designated an “A-B-A” sequence of polymers. It will be understood that section 32 of FIG. 3 illustrates only a representative cross section of a polymer stream according to aspects of the invention, and according to aspects of the invention, 3 or more polymers arranged in a myriad of relative positions may be handled according to aspects of the invention. For example, section 32 may include 3 or more polymers, A, B, C, etc. arranged in any desired sequence, including, but not limit to, A-B, A-B-C, A-B-A-C, A-B-C-A, A-B-B-C, etc., among others.

According to one aspect, as shown in FIG. 3, cross section 32 may be divided into cross section 34. In this aspect, cross section 32 was divided substantially in half along its height dimension H to produce cross section 34 comprising two substantially identical cross sections 36 and 38, vertically disposed from each other and each having the polymer sequence A-B-A. Though the cross sections 36 and 38 may represent a cross section substantially half the height H of second 32, the cross sections 36 and 38 need not be equal in height, but may comprise other complementary fractions of the height H of section 32, for example, ¼-¾, ⅓-⅔, etc., of height H.

According to one aspect, as shown in FIG. 3, the shape or aspect ratios of cross sections 36 and 38 may be varied into cross sections 42 and 44, as shown at 40. In this aspect, aspect ratio, that is, the ratio of the height to width, of cross sections 36 and 38 may be varied as desired. The aspect ratio of polymer streams 36 and 38 may be varied from a first aspect ratio shown at 34 to any second aspect ratio shown at 40. For example, in the aspect shown at 40, the aspect ratios of sections 36 and 38 were varied whereby the height of sections 36 and 38 were increased to produce a height of each cross section 42 and 44 substantially the same as the height H of initial cross section 32, and the width of cross sections 36 and 38 were decreased to produce a width of each cross section 42 and 44 of substantially about half of width W of initial cross section 32. Again, it will be understood that this change in aspect ratio shown between 34 and 40 is for illustration only; according to aspects of the invention any other fraction or multiple of the height H and the width W of cross section 32 may be produced by aspects of the invention. In addition, the aspect ratio variation represented by cross sections 36 and 38 and 42 and 44, respectively, may have little or no relationship to the dimensions of initial cross section 32.

The change in aspect ratio illustrated at 40 in FIG. 3 may be practiced in the layer combining and programming process 16 shown in FIG. 1 and represented by combined stream 17 in FIG. 1. As shown in FIG. 3, though the manipulation of the polymer streams represented at 34 and 40 vary the number and aspect ratio of the respective polymer streams, the polymer sequence is maintained. That is, the sequence of adjacent polymer streams at 40 is the same as the A-B-A sequence of initial cross section 32.

Step 46 in FIG. 3 illustrates a further manipulation of the cross section of polymer streams according to aspects of the invention. As shown, in step 46, the position of polymer streams 42 and 44 at 40 is varied as shown at step 46 to the position of polymer streams 48 and 50. The position of polymer streams 42 and 44 may be varied from a first position shown at 40 to any second position shown at 46. According to aspects of the invention, the relative positions of the polymer streams represented by cross sections 48 and 50 may vary in any planar direction from the position of the polymer streams represented by cross sections 42 and 44 at 40. In the aspect shown in FIG. 3, polymer streams 42 and 44 are repositioned whereby polymer streams 48 and 50 are substantially horizontally coplanar with each other. However, according to aspects of the invention the relative position of polymer streams 48 and 50 may vary broadly, for example, streams 48 and 50 may not be coplanar, but horizontally or vertically off-set a predetermined distance. In addition, the cross section of at least one of polymer streams 48 and 50 may be rotated relative to the orientation of streams 42 and 44 at 40. This reposition may also be practiced in the layer combing and programming process 16 shown in FIG. 1 and represented by combined stream 17 in FIG. 1.

After repositioning as illustrated at 46 in FIG. 3, according to one aspect, the polymer streams represented by cross sections 48 and 50 may be combined to produce a single stream represented by cross section 54 at 52. In this aspect, the repositioned streams 48 and 50 are mated along a common boundary, as indicated by phantom line 56 in FIG. 3 and, typically, at least partially fused to produce a single contiguous polymer stream having a cross section 54.

In the aspect shown in FIG. 3, the initial cross section 32 is converted to cross section 54, which may have substantially the same height H and substantially the same width W as cross section 52 (that is, substantially the same aspect ratio), however, the sequence and width of respective polymers A and B have been varied. This repositioning and fusing illustrated at 52 in FIG. 3 may be practiced in the layer multiplying process 18 shown in FIG. 1 and represented by stream 19 in FIG. 1. Again, according to aspects of the invention, the manipulation of the polymer streams represented at 46 and 52 may maintain the initial polymer sequence. That is, the sequence of adjacent polymers streams 54 at 52 may be the same as the A-B-A sequence of initial cross section 32.

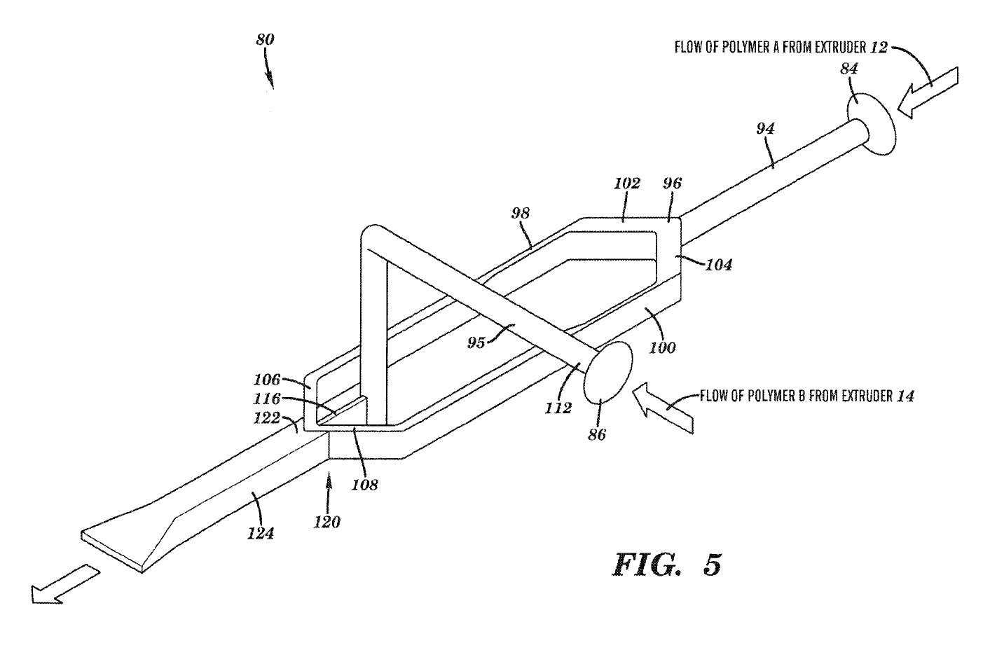

FIG. 4 is a perspective view of a device 60 for forming a multilayer laminate according to one aspect of the invention, for example, for practicing the processes illustrated in FIGS. 1 and 3. FIG. 5 is a perspectives view of the three-dimensional flow paths 80 of the polymers flowing through device 60 shown in FIG. 4 according to one aspect of the invention. According to aspects of the invention, device 60 includes a plurality of sections adapted to perform polymer stream manipulation, for example, as described in FIGS. 1 and 3.

As shown in FIG. 4, device 60 includes a housing 62 having at least two polymer inlets 64 and 66, for example, flanged inlets, operatively connected to respective sources of polymers. In the aspect shown, inlet 64 is operatively connected to extruder 12 identified in FIG. 1 and inlet 66 is operatively connected extruder 14 identified in FIG. 1. In the following discussion, for the sake of illustration, it is assumed that polymer A is introduced at inlet 64 and polymer B is introduced at inlet 66. It will be understood that although device 60 shown in FIG. 4 is only adapted to receive two streams of polymer, according to the invention, 2 or more streams may be introduced to device 60, for example, 5 or more, or 10 or more streams of polymers.

Device 60 includes a first section, or combining and feeding section, 68 adapted to receive polymers A and B from inlets 64 and 66, respectively, divide at least one stream of first polymer A into at least two streams of first polymer A, and combine the at least two streams of first polymer A with at least one stream of second polymer B, that is, a polymer different from first polymer A. Section 68 of device 60 may correspond to the layer combining and feeding step 16 of FIG. 1. Device 60 also includes a second section, or multiplying section, 70 adapted to receive the combined streams of polymers from first section 68 and multiply the combined streams into two or more combined streams. Section 70 of device 60 may correspond to the layer multiplying function 18 of FIG. 1. In addition, device 60 also includes a third section, or sheet forming section, 72 adapted to receive the multiple combined streams from second section 70 and produce a thin sheet or film 76 of the combined streams and discharging the sheet or film 76 from outlet 74. Section 72 of device 60 may correspond to the sheet or film forming function 20 of FIG. 1.

The details of combining and feeding section 68 are more clearly illustrated by FIG. 5 and the flow paths 80 shown in FIG. 5. As shown in FIGS. 4 and 5, the flow of polymer A from extruder 12 is introduced to inlet 64 in FIG. 4 and as indicated at 84 in FIG. 5 and introduced to an elongated passage in feeding section 68 represented by flow path 94 in FIG. 5, for example, flow path 94 may be a circular passage in section 68, though the passage may also be non-circular. As indicated by the bifurcation 96 at the end flow path 94 in FIG. 5, section 68 in FIG. 4 includes a flow divider adapted to divide the flow in the inlet passage 94 to two or more flows, as indicated by flow paths 98 and 100 in FIG. 5. As shown in FIG. 5, the passages 98, 100 in section 68 of FIG. 4 may have varying cross section. For example, as shown in FIG. 5, the flow passage in section 68 may vary from a first shape or aspect ratio at their beginning 102, 104, respectively, to a second shape or aspect ratio at their ends 106, 108, respectively. For example, the height and width of the flow passages 98 and 100 in section 68 of device 60 may vary from one end to the other. For instance, as shown in FIG. 5, the width of the flow paths 98 and 100 may be larger (or smaller) at the first end 102, 104 than the width at the second end 106, 108. In a similar manner, according to aspects of the invention, the height of the flow path 98 and 100 may be smaller (or larger) at the first end 102, 104 than the height at the second end 106, 108. In one aspect, the height or the width of flow passage 98 and 102 may not vary from one end to the other. Again, though only two flow paths 98 and 100 are shown in FIG. 5, section 68 of device 60 may divide flow path 94 into two or more flow paths 98 and 100, for example, three or more, or four or more, flow paths evenly distributed about section 68 of device 60. In another aspect, the flow path 94 may not be divided but may comprise a single flow of polymer, for example, as indicated by flow path 98, that may be combined with one or more other polymer streams.

As shown in FIG. 5, section 68 of device 60 shown in FIG. 4 may also include at least one second inlet flow passage. As shown in FIGS. 4 and 5, the flow of polymer B from extruder 14 is introduced to inlet 66 as indicated at 86 in FIG. 5 and introduced to an elongated passage in section 68 represented by flow path 95 in FIG. 5. Flow path 95 may be a circular passage in section 68, though the passage may also be non-circular. According to aspects of the invention, the passage in section 68 corresponding flow path 95 in FIG. 5 may have varying cross section. As shown in FIG. 5, the flow passage 95 in section 68 may vary from a first shape or aspect ratio at the beginning 112 to a second shape or aspect ratio at its end 116. The shape, height, and/or width of the flow passage in section 68 of device 60 corresponding to flow path 95 may vary from one end to the other. For instance, as shown in FIG. 5, at the first end 112 of flow path 95 the path may be circular in cross section while at its end 116 flow path 95 may be rectangular in cross section, for example, to comply with the shape of low paths 98 and 100 to which flow path 95 is combined. The variation in the cross section of flow path 95 may occur gradually, for example, similar to the variation in the shape of flow paths 98 and 100, or abruptly. As shown in FIG. 5, the shape of flow path 95 may transition abruptly from a circular flow path to a rectangular flow path. Again, though only a single flow path 95 is shown in FIG. 5, section 68 of device 60 may divide flow path 95 into two or more flow paths, for example, three or more, or four or more, flow paths evenly distributed about section 68 of device 60.

As indicated at 120 in FIG. 5, section 68 of device 60 shown in FIG. 4 may also combine one or more streams of polymers to produce a single stream as represented by flow path 122. For example, as shown in FIG. 5, section 68 may include internal passages that converge as indicated by flow path convergence 120 in FIG. 5. For instance, as shown in FIG. 5, section 68 shown in FIG. 4 may typically include flow passages that converge flow paths 98 and 100 of polymer A with flow path 95 of polymer B to provide a combined flow 122 of polymer A and B. Based upon the geometry and orientation of flow paths 95, 98, and 100 shown in FIG. 5, the polymer flow in path 122 in FIG. 5 may be somewhat like the A-B-A sequence and orientation illustrated by cross section 32 in FIG. 1. Of course, according to other aspects of the invention, with varying number of flow paths and varying numbers of polymers A, B, C, etc, introduced to section 68 of device 60, varying sequences of adjacent polymers may be provided by section 68 according to aspects of the invention.

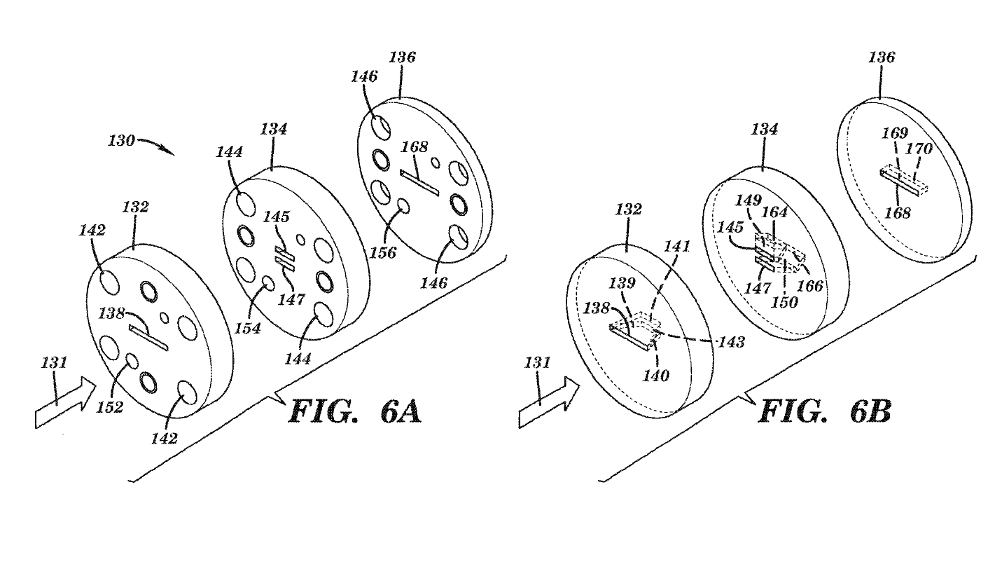

As shown in FIG. 4, the polymer streams combined in section 68 of device 60 are then introduced to multiplying section 70 according to aspects of the invention. The flow of polymer in section 70 of device 60 is represented by flow path 124 in FIG. 5. According to aspects of the invention, flow paths providing the multiplying and repositioning of multiplying section 70 may be provided by a series of plates having cooperating flow passages that define the desired polymer flow division, realignment, and recombination. FIG. 6A is an exploded perspective view of three polymer flow transition plates 130 that may be used in section 70 of device 60 according to one aspect of the invention. FIG. 6B is a wire frame view of the polymer flow transition plates shown in FIG. 6A. Miscellaneous mounting and alignment holes shown in FIG. 6A were omitted from FIG. 6B to facilitate illustration of aspects of the invention.

As shown in FIG. 6A, section 70 of device 60 may comprise a plurality of plates 130 providing the desired multiplying and positioning desired. As shown, plates 130 may include three plates 132, 134, and 136, though more or less plates may be used depending upon the desired manipulation. Plates 132, 134, and 136 may be any desired shape, for example, square, rectangular, polygonal, etc., to provide the desired flow paths. In the aspect shown in FIGS. 6A and 6B, plates 132, 134, and 136 are circular in cross section and include a plurality of holes to facilitate assembly and alignment of the plates as needed. For example, plates 132, 134, and 136 may each include a plurality of through holes 142, 144, and 146, respectively, to receive mounting hardware, not shown, for example, threaded bolts that retain plates 132, 134, and 136 in device 60. Plates 132, 134, and 136 may also include structures to aid in aligning the respective flow paths in plates 132, 134, and 136, for example, one or more dowel pin holes 152, 154, and 156, respectively, adapted to receive alignment or dowel pins, not shown.

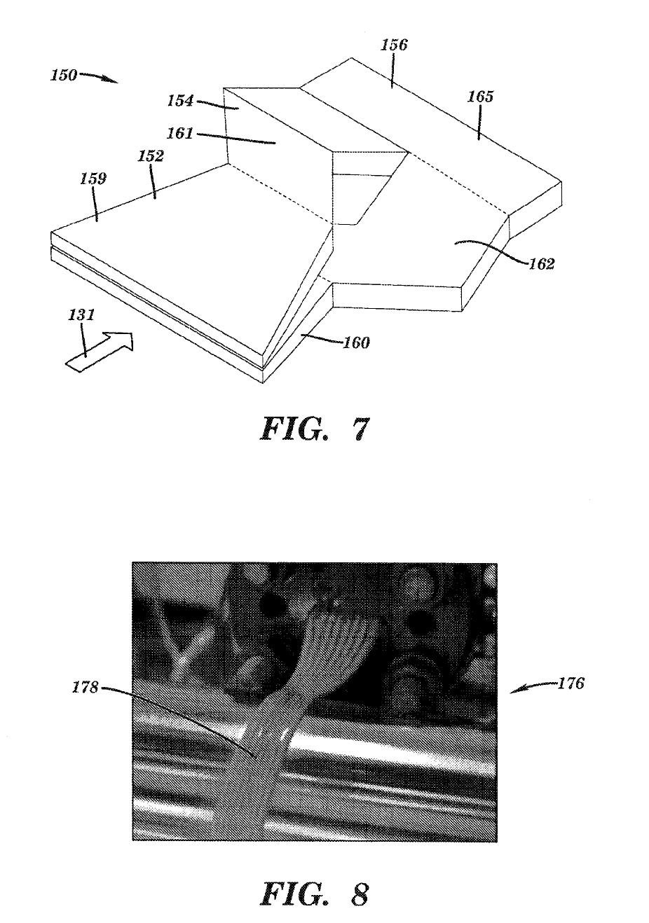

Plate 132 may typically be positioned to receive a flow of polymer, as indicated by arrow 131 in FIGS. 6A and 6B, from section 68. According to aspects of the invention, plates 132, 134, and 136 include flow passages that provide the desired polymer division and repositioning. FIG. 7 is a detailed perspective view of the three-dimensional flow paths 150 of the polymers provided by plates 132, 134, and 136 shown in FIGS. 6A and 6B according to one aspect of the invention. Arrow 131 in FIGS. 6A and 6B is also shown in FIG. 7 for reference. Flow paths 152, 154, and 156 shown in FIG. 7 correspond to the flow of polymer in plates 132, 134, and 136, respectively.

As shown in FIGS. 6A and 6B, plate 132 includes an inlet 138 into divided flow paths 139 and 140, corresponding to flow paths 159 and 160 shown in FIG. 7, and outlets 141 and 143, respectively. Plate 132 functions to divide the polymer flow 131 into two polymer flows 159 and 160. Plate 134 includes inlets 145 and 147, corresponding to outlets 141 and 143 of plate 132, respectively, and flow paths 149 and 150, corresponding to flow paths 161 and 162 shown in FIG. 7, and outlets 164 and 166, respectively. Plate 134 functions to reposition polymer flows 159 and 160 to polymer flows 161 and 162, respectively. Plate 136 includes inlet 168, corresponding to outlets 164 and 166 of plate 134, respectively, and flow path 169, corresponding to flow path 165 shown in FIG. 7, and outlet 170. Plate 136 functions to combine and position polymer flows 161 and 162 to a single flow 165, for example, for further processing. Again, though only a singe set of plates 132, 134, and 136 are shown in FIGS. 6A and 6B, according to aspects of the invention, further sets of similar plates having one or more flow similar passages may be provided. For example, additional plates, that is, plates having multiple flow passages similar to plates 132 and 134, may be provided between plates 134 and 136 that further divide and reposition the steams discharged from plate 134.

Returning to FIG. 4, the combined polymer flow (flow 165 in FIG. 7) produced by multiplying section 70 is forwarded to sheet forming section or die 72. According to aspects of the invention, sheet-forming section 72 is adapted to produce a thin sheet or film 76 of the combined streams 165 and discharge the sheet or film from outlet 74. In one aspect, the thin sheet or film 76 discharged from outlet 74 comprises a plurality of polymer components. These polymer components may have firmly and uniformly aligned layers and the layers may be oriented substantially perpendicularly to the width of sheet or film 76, for example, in substantially vertically oriented layers 28 as shown in FIG. 2. FIG. 8 is a photograph of a polymer film 176 having multiple vertically oriented layers 178 produced by aspects of the present invention.

As discussed above, although any material which is flowable and hardenable can be used as the hardenable fluid to be used in aspects of the invention, the flowable material typically comprises a polymer according to aspects of the invention. Examples of the polymers that may be used include resins, for example, resins having a homopolymer as a main component, for example, a polyolefin, such as, polyethylene or polypropylene; a poly(aromatic vinyl), such as, polystyrene, polymethyl methacrylate, poly(vinyl alcohol), vinyl chloride resin, or polyethylene terephthalate; a polyester, such as, polyethylene-2,6-naphthalate or polybutylene terephthalate; a polyamide, such as, nylon 6 (polycaprolactam) or nylon 66 (poly(hexamethylenediamine-co-adipic acid)); a polycarbonate, such as, polybisphenol A carbonate; a polyoxymethylene; a polysulfone; or a combination or copolymer thereof. The hardenable fluid may be a mixture of two or more of the above resins.

In one aspect, when a polyester copolymer is used, the polyester may have, as the copolymer component thereof, a dicarboxylic acid component or a glycol component. Examples of the dicarboxylic acid component include aromatic dicarboxylic acids, such as, isophthalic acid, phthalic acid, or naphthalenedicarboxylic acid; aliphatic dicarboxylic acids, such as, adipic acid, azelaic acid, sebacic acid, or decanedicarboxylic acid; and alicyclic dicarboxylic acids, such as, cyclohexanedicarboxylic acid. Examples of the glycol component that may be used in aspects of the invention include, but are not limited to, aliphatic diols, such as, butanediol and hexanediol; and alicyclic diols, such as, cyclohexanedimethanol.

One or more of the hardenable materials that may be used may include an elastomer, for example, natural rubber, isoprene rubber, urethane elastomer, polyamide elastomer, and styrene elastomer, or combinations thereof.

The flowable material composed of, for example, one or more of the above materials may also contain organic or inorganic additives, such as, a plasticizer, a process oil, a lubricant, a photostabilizer, a flame retarding agent, an antistatic agent, an anti-sticking agent, a UV absorber, an antioxidant, a foaming agent, and a photopolymerization initiator, or a combination thereof.

According to another aspect of the invention, the viscosities of the one or more hardenable fluids used may be about the same or may vary. In one aspect, a multilayer laminate having firmly and uniformly aligned layers can be obtained when a difference in the melt viscosity between the first hardenable fluid and the second hardenable fluid is small, for example, at a practical molding temperature and a shear rate of approximately 15 per second (s⁻¹). A melt viscosity ratio of the hardenable materials (that is, the ratio of the melt viscosity of the material having a higher melt viscosity to the melt viscosity of the material having a lower melt viscosity) arranged adjacent to each other is typically about 10 or less, for instance, about 5 or less, and preferably about 3 or less at a shear rate of approximately 15 s⁻¹. For example, a first hardenable fluid may have first viscosity and the second hardenable fluid may have a second viscosity, lower than the first viscosity. The ratio of the first viscosity to the second viscosity (regardless of viscosity units) may be less than about 10, for example, the ratio may be less than about 5, for instance, the ratio may be less than about 3 or even less.

### EXAMPLES OF ASPECTS OF THE INVENTION

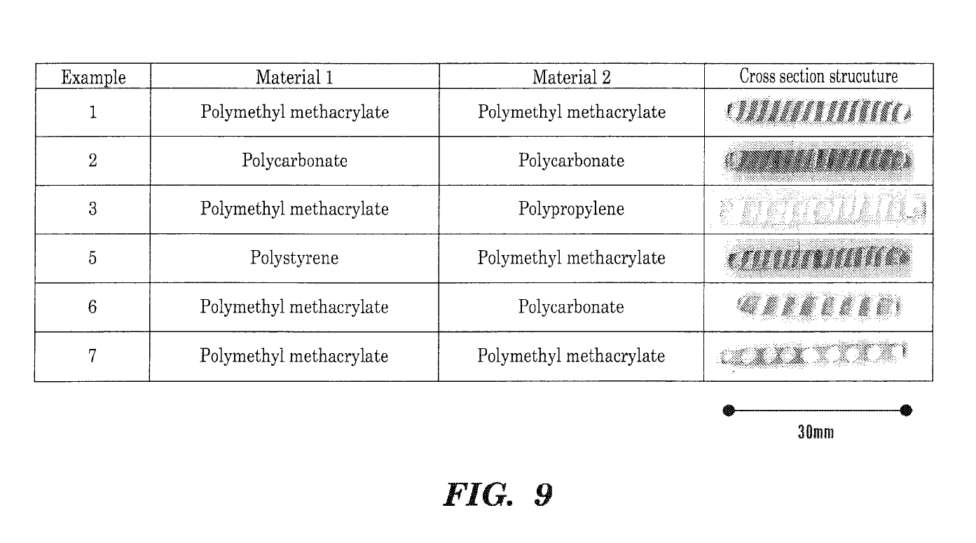

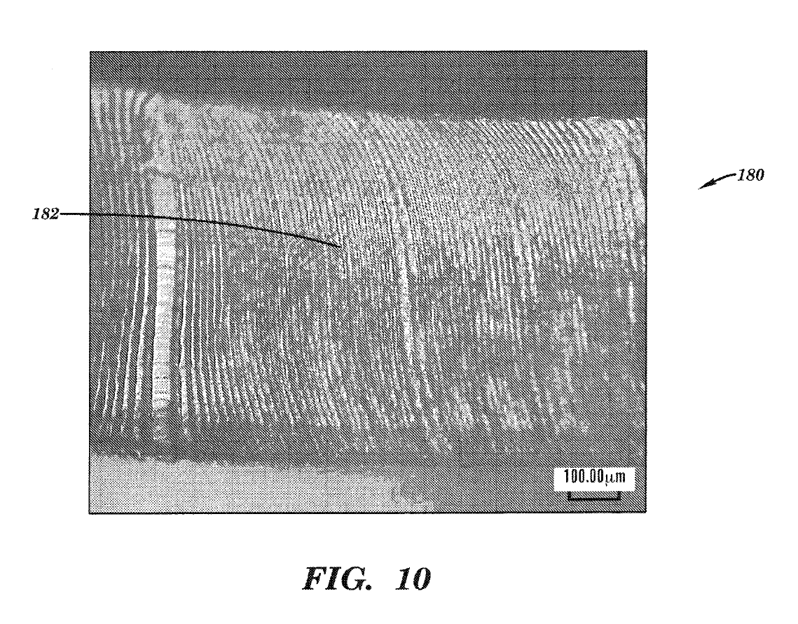

Examples of layer structures of multilayer laminates formed using two hardenable fluids and the laminate forming device 60 shown in FIG. 4 through 7 are now provided. The efficacy of aspects of the invention will be confirmed and verified by examination of the laminates produced by forming devices according to aspects of invention. Evaluation methods of physical properties employed are also provided. The polymers used and the results obtained for these examples are summarized in a table in FIG. 9.

### (1) Constitution of Layers, Number of Layers Arranged

The layer constitution of a multilayer laminate is determined by examination of samples of the layers produced. These samples may typically be obtained by cutting the multilayer laminate cross-sectionally with a precision, low-speed cutter “microtome,” through a transmission-type optical microscope, for example, a “BX50” optical microscope provided by Olympus, and a laser microscope, for example, a “VK-9500” laser microscope provided KEYENCE. Depending upon the dimensions of the layers produced, for example, the layers may have dimensions on the nanometer scale, aspects of the invention may also be examined using a scanning electron microscope or an atomic force microscope.

### (2) Measurement of Melt Viscosity

Dynamic viscoelasticity of the sample is measured using a rotary rheometer, for example, an “ARES” rotary rheometer provided by TA Instruments. The measurement is conducted using parallel discs (diameter: 40 mm) under the conditions of a N₂ atmosphere, a molding temperature in each of the examples below, a strain amount of 3%, and a shear rate of from 1 to 100 s⁻¹. Of the data thus obtained, a complex viscosity coefficient at shear rate of 15 s⁻¹ is designated as a “shear viscosity.” Resins used for film formation after drying in the examples are also dried in the present measurement under similar conditions.

### Example 1

A polymethyl methacrylate (PMMA, “Parapet GF”; product of KURARAY) and a material obtained by adding a small amount of a cyanine blue, a blue pigment (“Cyanine Blue 4937”; product of Dainichiseika Color & Chemicals) to polymethyl methacrylate (PMMA, “Parapet GF”) were prepared as a first hardenable material and a second hardenable material, respectively. The resulting hardenable materials 1 (PMMA without blue pigment) and 2 (PMMA with blue pigment) were dried at 80° C. for a whole day and night and then supplied to respective extruders.

The hardenable materials 1 and 2 were melted at 250° C. in the respective extruders. After weighing with a gear pump, they were introduced into a supply block via respective inlet tubes and then divided into two streams, repositioned, and then laminated by using the apparatus as illustrated in FIG. 6. While maintaining the laminated state of the layers, the layers were introduced into a roller, whereby a multilayer laminate having 17 first layers (PMMA without blue pigment) and 16 second layers (PMMA with blue pigment) alternately arranged in a vertical direction was formed.

### Example 2

A polycarbonate (PC, “Lexan 121R”; product of SABIC) and a material obtained by adding a small amount of a cyanine blue, a blue pigment (“Cyanine Blue 4937”) to the polycarbonate were prepared as a first hardenable material (PC without blue) and a second hardenable material (PC with blue), respectively. The resulting hardenable materials 1 and 2 were dried at 120° C. for a whole day and night, and then supplied to respective extruders.

The hardenable materials 1 and 2 were melted at 250° C. in the respective extruders. After weighing with a gear pump, they were introduced into a supply block via respective inlet tubes and then, divided into two streams, repositioned, and laminated by using the apparatus as illustrated in FIG. 6. While maintaining the laminated state of the layers, the layers were introduced into a roller, whereby a multilayer laminate having 17 first layers (PC without blue) and 16 second layers (PC with blue) alternately arranged in a vertical direction was formed.

### Example 3

A polymethyl methacrylate (PMMA, “Parapet G”) and a polypropylene (PP, “P4G3Z-050”; product of Huntsman) were prepared as a first hardenable material and a second hardenable material, respectively. After the hardenable material 1 was dried at 80° C. for a whole day and night, the hardenable materials 1 and 2 were supplied to respective extruders.

The hardenable materials 1 (PMMA) and 2 (PP) were melted at 230° C. in the respective extruders. After weighing with a gear pump, they were introduced into a supply block via respective inlet tubes and then, divided into two streams, repositioned, and laminated by using the apparatus as illustrated in FIG. 6. While maintaining the laminated state of the layers, they were introduced into a roller, whereby a multilayer laminate having 9 first layers (PMMA) and 8 second layers (PP) alternately arranged in a vertical direction was formed.

### Example 4

A polypropylene (PP, “P4C5B-03”; product of Huntsman) and a thermoplastic polyolefin elastomer (POE, “Engage 8440”; product of Dupont Dow Elastomer) were prepared as a first hardenable material and a second hardenable material, respectively. They were supplied to respective extruders.

The hardenable materials 1 (PP) and 2 (POE) were melted at 220° C. in the respective extruders. After weighing with a gear pump, they were introduced into a supply block via respective inlet tubes and then, divided into two streams, repositioned, and laminated by using the apparatus as illustrated in FIG. 6. While maintaining the laminated state of the layers, they were introduced into a roller, whereby a multilayer laminate having 513 first layers (PP) and 512 second layers (POE) alternately arranged in a vertical direction was formed.

### Example 5

A polystyrene (PS, “HRM-12”; product of Toyo Styrene) and a material obtained by adding a small amount of a cyanine blue (“Cyanine Blue 4937”) to a polymethyl methacrylate (PMMA, “Parapet GF”) were prepared as a first hardenable material and a second hardenable material, respectively. After the hardenable material 2 (PMMA with blue) was dried for a whole day and night at 80° C., the hardenable materials 1 and 2 were supplied to respective extruders.

The hardenable materials 1 (PS) and 2 (PMMA with blue) were melted at 240° C. in the respective extruders. After weighing with a gear pump, they were introduced into a supply block via respective inlet tubes and then, divided into two streams, repositioned, and laminated by using the apparatus as illustrated in FIG. 6. While maintaining the laminated state of the layers, they were introduced into a roller, whereby a multilayer laminate having 17 first layers (PS) and 16 second layers (PMMA with blue) alternately arranged in a vertical direction was formed. A melt viscosity ratio of the hardenable materials 1 and 2, more specifically, a melt viscosity ratio of the hardenable material having a higher melt viscosity to the other one, at the molding temperature of 240° C., is 2.70.

### Example 6

Examples 6 and 7 represent an investigation into the influence of the difference in melt viscosity upon aspects of the invention. In Example 6, polymers having a small difference in melt viscosity were used, while in Example 7, polymers having a large difference in melt viscosity were used.

A material obtained by adding a small amount of a cyanine blue (“Cyanine Blue 4937”) to polymethyl methacrylate (PMMA, “Parapet GH-1000S”; product of KURARAY) having a melt viscosity of 860 Pa/s was prepared as a first hardenable material, while the polycarbonate used in Example 2 (PC, “Lexan 121R”) and having a melt viscosity of 1370 Pa/s was prepared as a second hardenable material. After the hardenable materials 1 and 2 were dried at 80° C. and 120° C., respectively, for a whole day and night, they were supplied to respective extruders.

The hardenable materials 1 and 2 were melted at 250° C. in the respective extruders. After weighing with a gear pump, they were introduced into a supply block via respective inlet tubes and then, divided into two streams, repositioned, and laminated by using the apparatus as illustrated in FIG. 6. While maintaining the laminated state of the layers, the layers were introduced into a roller, whereby a multilayer laminate having 17 first layer (PMMA with blue) and 16 second layers (PC) alternately arranged in a vertical direction was formed. The melt viscosity ratio of the hardenable materials 1 and 2, more specifically, the melt viscosity ratio of the hardenable material having a higher melt viscosity to the other one, at the molding temperature of 250° C., is 1.59.

### Example 7

A material obtained by adding a small amount of a cyanine blue (“Cyanine Blue 4937”) to polymethyl methacrylate (PMMA, “Parapet GH-1000S”) having a melt viscosity of 563 Pa/s was prepared as a first hardenable material, while polymethyl methacrylate (PMMA, “Parapet EH”, product of KURARAY) having a melt viscosity of 2700 Pa/s was prepared as a second hardenable material. After the hardenable materials 1 and 2 were dried at 80° C. for a whole day and night, they were supplied to respective extruders.

The hardenable fluids 1 (PMMA low visc.) and 2 (PMMA high visc.) were melted at 250° C. in the respective extruders. After weighing with a gear pump, they were introduced into a supply block via respective inlet tubes and then, divided into two streams, repositioned, and laminated by using the apparatus as illustrated in FIG. 6. While maintaining the laminated state of the layers, they were introduced into a roller, whereby a multilayer laminate having 17 first layers (PMMA low visc.) and 16 second layers (PMMA high visc.) alternately arranged in a vertical direction was formed. The melt viscosity ratio of the hardenable materials 1 and 2, more specifically, the melt viscosity ratio of the hardenable material having a higher melt viscosity to the other hardenable material, at the molding temperature of 250° C., is 5.54.

The polymers used and the results obtained for Examples 1 through 7 are summarized in a table in FIG. 9. FIG. 9 includes representative cross-sectional views of the multilayer laminates obtained in Examples 1 through 7 according to aspects of the invention. As clearly shown in FIG. 9, aspects of the invention can provide multilayer laminates, in particular, vertically-oriented multilayer laminates, from various polymers and from various polymers of varying viscosity ratios.

### Example 8

### Film

In a similar manner, layers were prepared using the resins of Example 2 and then introduced into a roller, whereby a ribbon was formed. The ribbon thus obtained had a width of 2.2 mm and thickness of 190 μm.

FIG. 10 is a photograph 180 of a multilayer laminate 182 produced according to an aspect of the invention. In the aspect show, 1025 individual, alternating layers of a polypropylene (PP) and a thermoplastic polyolefin elastomer (POE) were laminated to provide laminate 182. As indicated by the scale on photograph 180, each individual layer of laminate 182 may be less than about 0.01 mm thick. As indicated by FIG. 10, aspects of the invention may be used to fabricate laminates having thousands of individual polymer layers.

Although several aspects of the present invention have been depicted and described in detail herein to facilitate discloser of aspects of the invention, it will be apparent to those skilled in the relevant art that various modifications, additions, substitutions, and the like can be made without departing from the spirit and scope of the claimed invention, and these are therefore considered to be within the scope of the invention as defined in the following claims.

1. A method of forming a vertically-oriented multilayer laminate comprising:
providing at least a first stream of a first hardenable fluid and a second stream of a second hardenable fluid;
combining the first stream with the second stream to provide a combined stream of fluid comprising the first fluid and the second fluid;
dividing the combined stream into a plurality of streams, each of the plurality of streams comprising the first fluid and the second fluid;
positioning the plurality of streams laterally adjacent each other; and
fusing the plurality of laterally adjacent streams to provide a vertically oriented multilayer laminate.

2. The method as recited in claim 1, wherein the method further comprises dividing the first stream into two streams of the first fluid, and wherein combining the first stream with the second stream comprises combining the two streams of the first fluid with the second stream to provide the combined stream.

3. The method as recited in claim 1, wherein dividing the combined stream into a plurality of streams comprises introducing the combined stream to a plurality of flow passages.

4. The method as recited in any one of claims 1, wherein positioning the plurality of streams laterally adjacent each other comprises passing the plurality of streams through separate flow passages.

5. The method as recited in claim 4, wherein positioning the plurality of streams laterally adjacent each other comprises discharging the plurality of streams from a plurality of laterally adjacent outlets.

6. The method as recited in any one of claims 1, wherein the first hardenable fluid and the second hardenable fluid comprise a first fluid polymer and a second fluid polymer.

7. The method as recited in any one of claims 1, wherein the first hardenable fluid comprises a first viscosity and the second hardenable fluid comprises a second viscosity, greater than the first viscosity, wherein the ratio of the first viscosity to the second viscosity is less than about 3.

8. The method as recited in any one of claims 1, wherein the method further comprises providing at least a third stream of a third hardenable fluid; and wherein combining the first stream with the second stream comprises combining the first stream, the second stream, and the third stream to provide the combined stream of fluid comprising the first fluid, the second fluid, and at least the third fluid; and wherein dividing the combined stream into a plurality of streams comprises dividing the combined stream into the plurality of streams each comprising the first fluid, the second fluid, and the third fluid.

9. The method as recited in claim 8, wherein at least two of the first hardenable material, the second hardenable material, and the third hardenable material comprise substantially the same hardenable material.

10. The method as recited in claim 9, wherein the method comprises providing and combining the third stream of the third hardenable fluid.

11. The method as recited in claim 1, wherein the vertically oriented multilayer laminate includes at least 1,000 individual layers.

12. A vertically-oriented multilayer laminate forming device comprising:
a feed block adapted to receive a first stream of a first hardenable fluid and a second stream of a second hardenable fluid and combine the first stream with the second stream to provide a combined stream of hardenable fluid comprising the first fluid and the second fluid;
a layer multiplying section adapted to divide the combined stream into a plurality of streams, each of the plurality of streams comprising the first fluid and the second fluid;
a layer positioning section adapted to position the plurality of streams laterally adjacent each other; and
a layer fusing section adapted to fuse the plurality of latterly adjacent streams to provide a vertically oriented multilayer laminate.

13. The device as recited in claim 12, wherein the device further comprises a divider adapted to divide the first stream into two first streams of the first polymer, and wherein the feed block is adapted to combine the two first streams with the second stream to provide the combined stream.

14. The device as recited in claim 13, wherein the layer multiplying section comprises a plurality of flow passages.

15. The device as recited in any one of claims 12, wherein the layer positioning section comprises a plurality of separate flow passages.

16. The device as recited in claim 15, wherein the layer positioning section further comprises a plurality of laterally adjacent outlets.

17. The device as recited in any one of claims 12, wherein the first hardenable fluid and the second hardenable fluid comprise a first fluid polymer and a second fluid polymer.

18. The device as recited in any one of claims 12, wherein the feed block is further adapted to receive a third stream of a third hardenable fluid and combine the first stream, the second stream, and the third steam to provide the combined stream of hardenable fluid comprising the first fluid, the second fluid, and the third fluid; and wherein the layer multiplying section is adapted to divide the combined stream into a plurality of streams, each of the plurality of streams comprising the first fluid, the second fluid, and the third fluid.

19. The device as recited in claim 18, wherein the device is adapted to combine the third stream of the third hardenable fluid.

20. The device as recited in claim 12, wherein the vertically oriented multilayer laminate includes at least 1,000 individual layers.
